(19) United States
(12) Patent Application Publication
(10) Pub. No.: US 2026/0069476 A1
(43) Pub. Date: Mar. 12, 2026

(54) LIFT CHAIR

(71) Applicant: BA HEALTHCARE, PACE (FR)

(72) Inventors: Nicolas AUTREL, MELESSE (FR); Olivia RUMIAC, NOYAL-CHÂTILLON-SUR-SEICHE (FR); Yves BEAULIEU, PERROS-GUIREC (FR); Maxime LETOUZÉ, CESSON-SEVIGNÉ (FR); Maxime GUERRANT, RENNES (FR)

(21) Appl. No.: 19/321,648

(22) Filed: Sep. 8, 2025

(30) Foreign Application Priority Data
Sep. 6, 2024 (FR) 2409496

(51) Int. Cl. A61G 5/14; A61G 5/10

(52) U.S. Cl. CPC A61G 5/14; A61G 5/1059

(57) ABSTRACT

A lift chair for a disabled user is presented. The lift chair comprises a seat, a backrest, and a footrest. A seat movement mechanism is adapted to transition the chair from a first position to a second position and conversely. The footrest is adapted to move horizontally as the seat movement mechanism moves the seat between the first position to the second position. A movement of the footrest is linked to the movement of the seat but is mechanically independent of the movement of the seat. A coordinated movement of the seat and footrest is adapted to move a center of gravity of the user on a vertical line between the first position to the second position.

### TECHNICAL FIELD

This disclosure relates to the field of lift chairs, in particular wheelchairs, which enable a person to move from a “sitting” position to at least a “half-standing” position, intended in particular for people with reduced mobility and those who are disabled.

### PRIOR ART

People with disabilities who use wheelchairs suffer from physiological problems due to remaining in a “sitting” position for extended periods. In addition, they suffer from not being at the same height as able-bodied people during everyday interactions.

Lift chairs have emerged to address these problems. They are hinged so they can transition from a “sitting” position to a “half-standing” position or to a “standing” position. In the “sitting” position, the user's torso is approximately 90 degrees from the thighs. In the upright position, the user's torso is approximately 180 degrees from the thighs. In the “half-standing” position, the user is not completely vertical, and the torso is at an angle between approximately 90 degrees and approximately 180 degrees. According to one embodiment, the “half-standing” position has a torso angle of approximately 135 degrees from the thighs. The “sitting” and “half-standing” positions can be optimized for each user.

The benefits of standing can include the following: placing weight on the bones allows better growth and prevents osteoporosis; standing also improves blood circulation, bowel movements, and bladder emptying which thus prevents urinary tract infections. Finally, standing prevents skeletal deformities.

However, the lifting process may often be uncomfortable for the user, due to the often unnatural movement of the body.

### SUMMARY

A lift chair is proposed for a disabled user is proposed. The lift chair comprises a seat, a backrest, a footrest; and a seat movement mechanism adapted to move the seat between a first position and a second position. In the first position of the seat, a position of the user in the chair is such that an angle αct defined between a spine of the user in a straight position and a line Lp connecting a hip joint to a knee joint of the user is between 85 and 100 degrees. In the second position of the seat, the angle αct is between 130 and 140 degrees. A movement of the footrest is mechanically independent of a movement of the seat. The footrest is movable along a horizontal axis H. A coordinated movement of the seat and the footrest is adapted to move a center of gravity of the user on a line along a vertical axis V.

The lift chair may have one or more of the following characteristics:
the seat movement mechanism is adapted to move the seat along a travel line Co having a fixed angle α₁ relative to the vertical axis V.
The lift chair further comprises a footrest movement mechanism for moving the footrest along the horizontal axis.
The footrest movement mechanism is adapted to move the footrest according to a kinematics having a parabolic shape dependent on a position of the seat.
The kinematics of the footrest is the following:

$$d = {L}_{c} \times cos ( {α}_{ci} ) - \sqrt{\begin{matrix}L {}_{c}^{2} - ( \sqrt{{c}^{2} - {( c \times sin ( {α}_{i} ) )}^{2}} + \\ ( {L}_{c} \times cos ( {α}_{ci} ) - \\ c \times sin ( {α}_{i} ) ) \times \\ {tan ( {α}_{ci} ) )}^{2}\end{matrix}} - c \times sin ( {α}_{i} )$$

where d is a distance of the footrest along the horizontal axis H between a position of the footrest when the seat is in the first position and a position of the footrest at a time t when the seat is between the first position and the second position, Lc is a length of thighs of the user, α₁ is the angle of the travel line Co of the seat relative to the vertical axis V, αci is an initial angle of the thighs of the user relative to the horizontal axis H, and c is a distance along the travel line Co between a position of the hip joint in the first position and a position of the hip joint at time t between the first position and the second position of the seat.
when the seat transitions from the first position to the second position, the footrest has a fixed orientation relative to the horizontal axis H and the vertical axis V.
at least one of the footrest and the seat is free to pivot about an axis T which is transverse to the horizontal axis H and to the vertical axis V.
the seat is fixed in a horizontal plane when the seat is set in motion by the seat movement mechanism.
the coordinated movement of the seat and the footrest between the first position and the second position is adapted to adapted to move the ankles and knees of the user horizontally.
the coordinated movement of the seat and the footrest between the first position and the second position is adapted to maintain the lower leg of the user at a fixed angle αbdj to the horizontal axis H.
the footrest is mounted on at least one rail, and in the absence of the user, the footrest is able to move horizontally, so that when the user is seated in the chair with his or her feet on the footrest and the seat is set in motion by the seat movement mechanism, the movement of the footrest along the horizontal axis is transmitted passively by the user's body.
the backrest is fixed with respect to the seat.
the chair includes a self-balancing driving mechanism.

A lift wheelchair comprises a seat, a backrest, a footrest; and a seat movement mechanism adapted to move the seat between a first position and a second position. The footrest is adapted to move horizontally as the seat movement mechanism moves the seat between the first position to the second position. A movement of the footrest is linked to the movement of the seat but is mechanically independent of the movement of the seat. A coordinated movement of the seat and the footrest is adapted to move a center of gravity of the user on a vertical line between the first position to the second position.

A lift wheelchair comprises a seat, a backrest, a footrest; and a seat movement mechanism adapted to move the seat between a first position and a second position. The footrest is adapted to move horizontally as the seat movement mechanism moves the seat between the first position to the second position. A movement of the footrest is linked to the movement of the seat but is mechanically independent of the movement of the seat. A coordinated movement of the seat and the footrest is adapted to move a center of gravity of the user on a vertical line between the first position to the second position. The seat movement mechanism may be adapted to move the seat along a rectilinear travel line Co having a fixed non-zero angle α₁ relative to a vertical.

A lift wheelchair comprises a seat, a backrest, a footrest; and a seat movement mechanism adapted to move the seat between a first position and a second position. The footrest is adapted to move horizontally as the seat movement mechanism moves the seat between the first position to the second position, a movement of the footrest is linked to the movement of the seat but is mechanically independent of the movement of the seat. The seat movement mechanism is adapted to move the seat along a rectilinear travel line Co having a fixed non-zero angle α₁ relative to a vertical. A coordinated movement of the seat and the footrest may be adapted to move a center of gravity of the user on a vertical line between the first position to the second position.

A lift wheelchair comprises a seat, a backrest, a footrest; and a seat movement mechanism adapted to move the seat between a first position corresponding to a ‘sitting’ position and a second position corresponding to a ‘half-standing’ position. The footrest is adapted to move horizontally rearward as the seat movement mechanism moves the seat forward from the first position to the second position. A movement of the footrest is linked to the movement of the seat but is mechanically independent of the movement of the seat. The footrest and seat movements are such that ankles and knees of the user are moved horizontally with a lower leg of the user at a fixed angle αbdj with the horizontal. A coordinated movement of the seat and the footrest may be adapted to move a center of gravity of the user on a vertical line between the first position to the second position.

### BRIEF DESCRIPTION OF DRAWINGS

Other features, details, and advantages will become apparent upon reading the detailed description below and upon analyzing the attached drawings, in which:

FIG. 1 shows a lift chair with the user in a seated position according to one embodiment.

FIG. 2 shows the lift chair of FIG. 1 with the user in a “half-standing” position.

FIG. 3 shows kinematics of the body of a user of the chair of FIGS. 1 and 2, FIGS. 1 and 2 being superimposed on FIG. 3.

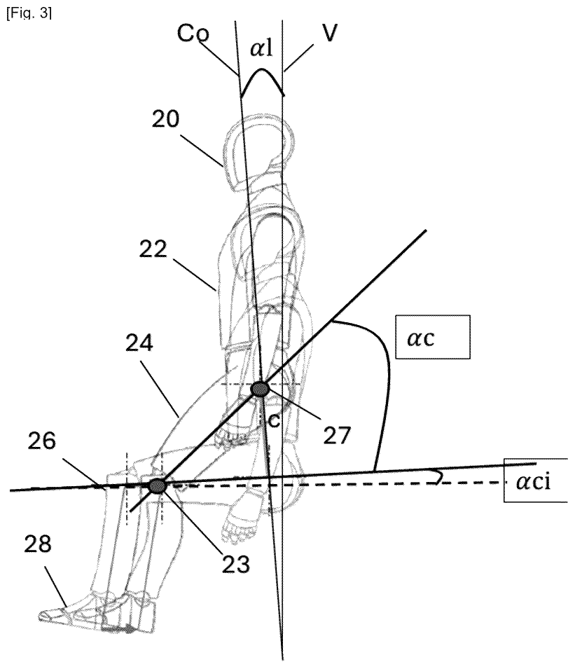

FIG. 4 shows a position of the user's torso when the chair is in the “half-standing” position, as well as associated reference angles.

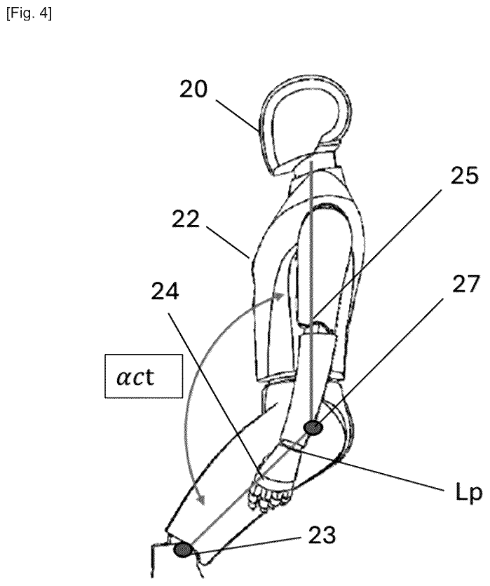

FIG. 5 shows a position of the user's feet when the chair is in the “sitting” position, along with the associated reference angles.

FIG. 6 shows a graph of the kinematic relationship between the footrest and the seat of the chair.

FIG. 7 shows various positions of use, between the “sitting” position (left) and the “half-standing” position (right).

FIG. 8 shows the footrest of the chair according to one embodiment.

FIG. 9 shows the seat of the chair according to one embodiment.

### DESCRIPTION OF EMBODIMENTS

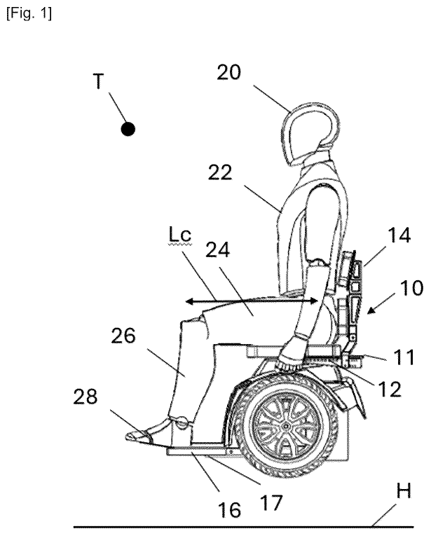

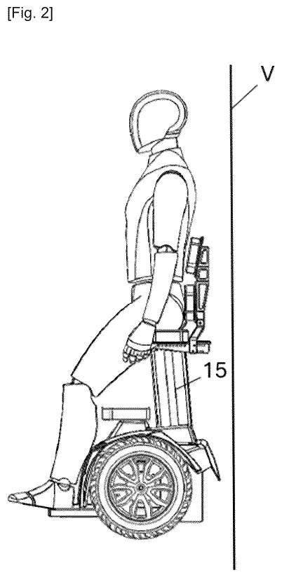

Reference is now made to FIGS. 1 and 2 which respectively show a lift chair 10 in the “sitting” and “half-standing” positions, according to one embodiment. In the “sitting” position of the chair 10, the user 20 is seated and the torso 22 of the user 20 (more precisely the spine 25 in a straight position) is at an angle αct of between 85 and 100 degrees relative to the thighs 24 (more precisely a line Lp connecting the hip joint 27 to the knee joints 23). FIG. 1 illustrates a normal “sitting” position of the user 20 in the “sitting” position of the chair 10. In the “half-standing” position of the chair 10, the user 20 is almost standing (i.e. almost in a vertical position), with the torso 22 of the user 20 at the angle αct of between 130 and 140 degrees relative to the thighs 24, preferably at 135 degrees.

The lift chair 10 may be a wheeled or stationary chair. In the case where the chair has wheels, it may be motorized or manual. According to one embodiment, the chair 10 is a gyropod (i.e. it includes a self-balancing driving mechanism). In the case of a self-balancing driving mechanism, the position of the user's center of gravity is used to maneuver the chair.

The chair 10 comprises a frame 11 supporting a seat 12 adapted to receive the buttocks and in certain cases the thighs 24 of the user 20, a backrest 14 against which the user 20 can lean, and a footrest 16 which receives the feet of the user 20. A seat movement mechanism 15 allows raising the seat 12 to transition the chair 10 from the “sitting” position to the half-standing position, and vice versa.

For the lifting action of the chair 10 (i.e. the movement to the “half-standing” position), the seat 12 (and therefore the user's hips) follows a rectilinear travel line Co having a fixed angle α₁ relative to a vertical axis V. According to one embodiment, the angle α₁ is between 8 and 3 degrees, preferably 5 degrees. By adopting a travel line Co that is not strictly vertical, the ergonomics of the user 20 are maintained during the lifting action.

The seat 12 movement mechanism 15 may allow the user 20 to be positioned in any intermediate position between the “sitting” and “half-standing” limit positions, along the travel line Co.

According to one embodiment, the seat 15 movement mechanism comprises a cylinder, such as a hydraulic or pneumatic cylinder, for ensuring the rectilinear travel line Co. The seat 15 movement mechanism may be controlled by the user 20 to actuate and stop the movement according to the needs of the user 20.

The footrest 16 is movable relative to the seat 12 along a horizontal axis H. Even if the footrest 16 moves between the “sitting” and half-standing positions of the chair 10, the movement of the footrest 16 is mechanically independent of that of the seat 12, and remains along the horizontal axis H.

The vertical V and horizontal H axes are the natural axes defined when the chair 10 is in a normal position on the ground.

According to one embodiment, the footrest 16 is free to move along the horizontal axis H. For example, the footrest 16 is mounted on one or more rails 17 arranged along the horizontal axis H, and is without constraints along this axis when the user 20 is not present; meaning that when the user 20 is not in the chair 10, the footrest 16 can move freely along the horizontal axis H. On the other hand, when the user 20 is in the chair 10, the user's feet 28 are on the footrest 16, such that, when the seat 12 is moved by the seat 15 movement mechanism, the body of the user 20 transmits this movement passively via the legs of the user 20. Thus, when the seat 12 rises, the footrest 16 is moved passively rearward along the horizontal axis H by the body of the user 20.

According to another embodiment, the footrest 16 has movement along the horizontal axis H that is controlled by a footrest movement mechanism. The active footrest movement mechanism is independent of the seat movement mechanism.

According to one embodiment, it is the user 20 who controls the kinematics of the footrest 16: for example, when the user wishes to adjust the position of the footrest 16 once he or she has adjusted the seat 12.

Whether the movement of the footrest 16 is controlled actively or passively, it is moved along the horizontal axis H towards the seat 12 during the lifting action and in the direction away from the seat 12 when transitioning from the half-standing position to the seated position. As indicated above, the seat 12 follows a movement along a rectilinear travel line Co at a fixed angle α₁ relative to the vertical axis V. It should be noted that when mentioning the position or movement of the seat along the travel line Co, this is understood to mean the position of the hip joint. Thus, if we break down the travel line, it has a vertical component and a horizontal component. During the lifting action, the footrest 16 and the horizontal component of the travel line Co 12 move so as to draw closer together horizontally. Conversely, when transitioning from the half-standing position to the seated position, the footrest 16 and the horizontal component of the travel line Co of the seat 12 move so as to travel further away from each other horizontally. This coordinated movement of the seat 12 and the footrest 16 contributes to ensuring that the user's center of gravity remains along a vertical line during the lifting action and when transitioning from the half-standing position to the seated position. This movement of the center of gravity along a vertical line is particularly advantageous when the chair includes a self-balancing driving mechanism since it prevents uncontrolled movements of the chair during its lifting action and when transitioning from the half-standing position to the seated position.

According to one embodiment, the footrest movement mechanism is programmed to move the footrest 16 according to kinematics that depend on those of the seat 12, in order to maintain an optimal anatomical position for the user 20. The footrest movement mechanism 16 provides movement of the footrest that is mechanically independent from the movement of the seat even if the kinematics may be dependent on those of the seat 12. The footrest 16 and the seat 12 have coordinated movement, but it is possible, for certain parts of the movement such as at the beginning or end of the movement, that only the seat 12 or only the footrest 16 moves.

According to one embodiment, the kinematics of the footrest 16 are purely a function of the movement of the seat 12. According to one embodiment, these kinematics have a parabolic shape. According to one embodiment, the dependence of the kinematics of the footrest 16 on the movement of the seat 12 may take into account physiological data of the user and/or the angle of the travel line Co of the seat 12.

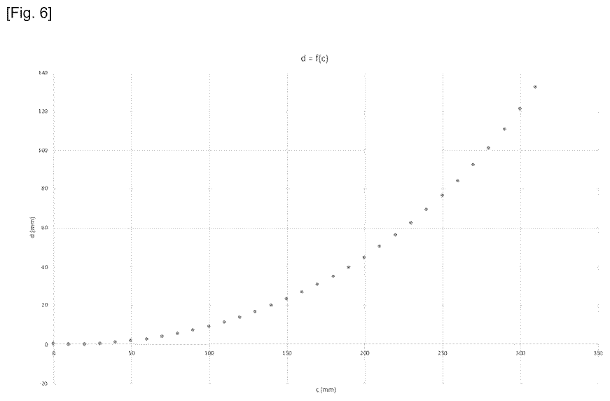

According to one embodiment and as illustrated in FIG. 6, the kinematics of the footrest 16 are as follows:

$$d = {L}_{c} \times cos ( {α}_{ci} ) - \sqrt{\begin{matrix}L {}_{c}^{2} - ( \sqrt{{c}^{2} - {( c \times sin ( {α}_{i} ) )}^{2}} + \\ ( {L}_{c} \times cos ( {α}_{ci} ) - \\ c \times sin ( {α}_{i} ) ) \times \\ {tan ( {α}_{ci} ) )}^{2}\end{matrix}} - c \times sin ( {α}_{i} )$$

where d is a distance of the footrest 16 along the horizontal axis H between a position of the footrest when the user 20 is in the “sitting” position and a position of the footrest at a time t between the “sitting” position and the “half-standing” position, Lc is the length of the thighs 24 of the user 20, α₁ is the angle of the travel line Co of the seat 12 relative to the vertical axis V, αci is an initial angle of the thighs 24 of the user 20 relative to the horizontal axis H, and c is the distance along the travel line Co between a position of the hip joint 27 in the “sitting” position and a position of the hip joint 27 at the time t between the “sitting” position and the “half-standing” position. The distance d varies as a function of the distance c, which varies over time when transitioning from the “sitting” position to the half-standing position and vice versa. Physiological data such as thigh length or limb angles may be adapted to each user or may be taken from observed averages.

The above specific movement can be particularly advantageous because it is gentle on the user's joints. The degree of rotation of the knee and hips relative to each other ensures smooth movement of the body between the half-standing and seated positions.

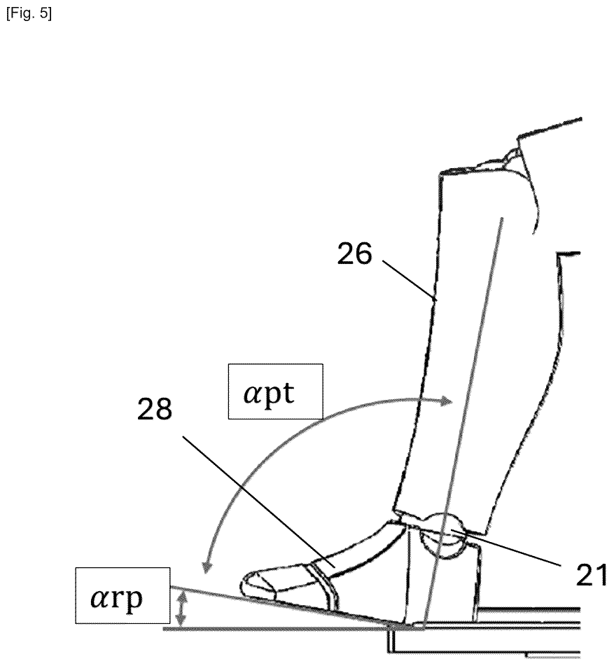

According to one embodiment, whether the footrest 16 moves freely or in a controlled manner along the horizontal axis H, the footrest 16 has a fixed orientation (angle αrp) that is identical at all times. The fixed orientation of the footrest 16 is preferably at an angle αrp of between 0 and 15 degrees, preferably at 10 degrees relative to the horizontal axis H. According to one embodiment, and as illustrated in FIG. 5, an angle αpt formed by the feet 28 and the shins 26 of the user 20 is 90 degrees. This angle can then be constant during the lifting action and when transitioning from the half-standing position to the seated position. Keeping this angle constant can be particularly advantageous for quadriplegic patients since it allows the ankle 21, lower leg 19, and knees 23 to be fixed.

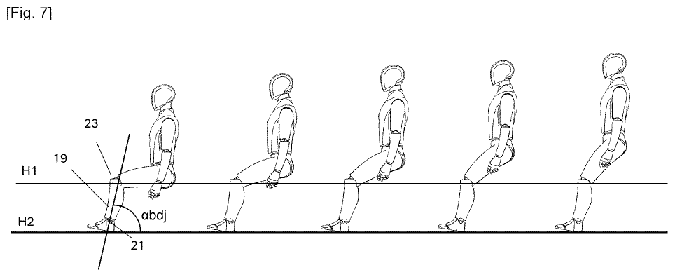

Thus, a preferred kinematics allows the ankle 21 and the knees 23 to move along parallel horizontal lines with the lower leg 19 kept at a fixed inclination (angle αbdj between a straight line joining the ankle and the knee being fixed relative to the horizontal). FIG. 7 shows an example of such kinematics. The ankles 21 move along a horizontal line H2 during the lifting action of the chair (the lifting action being observed in the figure by looking at the stylized patient from left to right), and when transitioning from the half-standing position to the seated position. The knees 23 move along a horizontal line H1 during the lifting action of the chair, and when transitioning from the half-standing position to the seated position. The lower leg 19 is kept at a constant inclination during the lifting action. The kinematics in FIG. 6 are an example of kinematics that allow keeping the ankles 21 and the knees 23 on parallel horizontal lines.

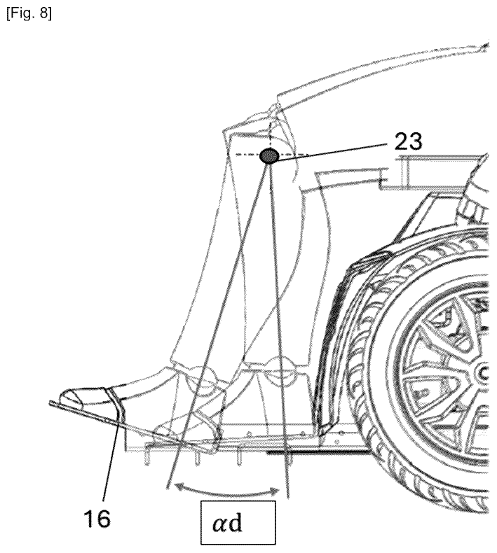

According to one embodiment and as illustrated in FIG. 8, whether the footrest 16 moves freely or in a controlled manner along the horizontal axis H, the footrest 16 is free to pivot about an axis T which is transverse to the horizontal axis H and to a vertical axis V (angle αd). The transverse axis T corresponds to the axis of rotation of the knee joint 23 and of the ankles 21 of the user 20. With this embodiment it is conceivable to allow a movement of the footrest 16, when the user 20 is seated, that is independent of the lifting movement of the seat 12. If we consider the lifting movement of the seat 12, the combination of this arrangement of the footrest 16 (pivot) during its horizontal movement makes it possible to improve the comfort of the user 20, as the footrest 16 automatically places itself at the optimal angle αd for the user load applied to it.

According to one embodiment, whether the footrest 16 moves freely or in a controlled manner along the horizontal axis H, the seat 12 remains fixed in a horizontal plane during the movement of its lifting action.

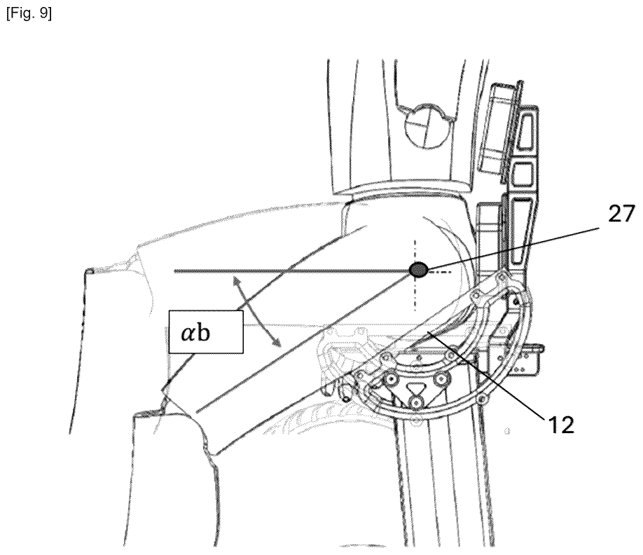

According to another embodiment and as illustrated in FIG. 9, whether the footrest 16 moves freely or in a controlled manner along the horizontal axis H, the seat 12 is able to pivot about the axis T, which is transverse to the horizontal axis H and to a vertical axis V (angle αb). This transverse axis T corresponds to the hip joints 27 of the user 20. The pivoting of the seat 12 on the transverse axis T may be free or controlled. When one considers the lifting movement of the seat 12, the combination of the pivoting of the seat 12 and its lifting makes it possible to the comfort of the user, as the seat 12 automatically places itself at the optimal angle for the user 20 load applied to it.

In the embodiments presented above, the backrest 14 may be fixedly connected to the seat 12. In such case, the backrest 14 moves along a line parallel to the travel line Co, while remaining in a vertical plane.

The kinematics described in the embodiments presented allow the center of gravity of the user 20 to change while he or she is raised along a perfectly vertical line. In the case of the chair 10 including a self-balancing driving mechanism, this ensures that the movement will have no influence on the stability of the base.

The angles presented in this application are to be considered with the usual margin of tolerance for the technical field of the invention.

What is claimed is:

1. A lift chair for a disabled user, the lift chair comprising:
a seat, a backrest, a footrest; and
a seat movement mechanism adapted to move the seat between a first position and a second position,
in the first position of the seat, a position of the user in the chair is such that an angle αct defined between a spine of the user in a straight position and a line Lp connecting a hip joint to a knee joint of the user is between 85 and 100 degrees, and
in the second position of the seat, the angle αct is between 130 and 140 degrees,
wherein a movement of the footrest is mechanically independent of a movement of the seat, the footrest is movable along a horizontal axis H, and a coordinated movement of the footrest and the seat is adapted to move a center of gravity of the user on a line along a vertical axis V.

2. The lift chair of claim 1, wherein the seat movement mechanism is adapted to move the seat along a travel line Co having a fixed angle α₁ relative to the vertical axis V.

3. The lift chair of claim 2, further comprising a footrest movement mechanism for moving the footrest along the horizontal axis.

4. The lift chair of claim 3, wherein the footrest movement mechanism is adapted to move the footrest according to a kinematics have a parabolic shape dependent on a position of the seat.

5. The lift chair of claim 4, wherein the kinematics of the footrest is the following:
$$d = {L}_{c} \times cos ( {α}_{ci} ) - \sqrt{\begin{matrix}L {}_{c}^{2} - ( \sqrt{{c}^{2} - {( c \times sin ( {α}_{i} ) )}^{2}} + \\ ( {L}_{c} \times cos ( {α}_{ci} ) - \\ c \times sin ( {α}_{i} ) ) \times \\ {tan ( {α}_{ci} ) )}^{2}\end{matrix}} - c \times sin ( {α}_{i} )$$
where d is a distance of the footrest along the horizontal axis H between a position of the footrest when the seat is in the first position and a position of the footrest at a time t when the seat is between the first position and the second position, Lc is a length of thighs of the user, α₁ is the angle of the travel line Co of the seat relative to the vertical axis V, αci is an initial angle of the thighs of the user relative to the horizontal axis H, and c is a distance along the travel line Co between a position of the hip joint in the first position and a position of the hip joint at time t between the first position and the second position of the seat.

6. The lift chair of claim 1, wherein when the seat transitions from the first position to the second position, the footrest has a fixed orientation relative to the horizontal axis H and the vertical axis V.

7. The lift chair of claim 1, wherein at least one of the footrest and the seat is free to pivot about an axis T which is transverse to the horizontal axis H and to the vertical axis V.

8. The lift chair of claim 1, wherein the seat is fixed in a horizontal plane when the seat is set in motion by the seat movement mechanism.

9. The lift chair of claim 1, wherein the coordinated movement of the seat and the footrest between the first position and the second position is adapted to move the ankles and the knees of the user horizontally.

10. The lift chair of claim 1, wherein the coordinated movement of the seat and the footrest between the first position and the second position is adapted to maintain the lower leg of the user at a fixed angle αbdj to the horizontal axis H.

11. The lift chair of claim 1, wherein the footrest is mounted on at least one rail, and in the absence of the user, the footrest is able to move horizontally, so that when the user is seated in the chair with his or her feet on the footrest and the seat is set in motion by the seat movement mechanism, the movement of the footrest along the horizontal axis is transmitted passively by the user's body.

12. The lift chair of claim 1, wherein the backrest is fixed with respect to the seat.

13. The lift chair of claim 1, wherein the chair includes a self-balancing driving mechanism.

14. A lift wheelchair comprising:
a seat, a backrest, a footrest; and
a seat movement mechanism adapted to move the seat between a first position and a second position,
wherein the footrest is adapted to move horizontally as the seat movement mechanism moves the seat between the first position to the second position, a movement of the footrest is linked to the movement of the seat but is mechanically independent of the movement of the seat, a coordinated movement of the seat and the footrest is adapted to move a center of gravity of the user on a vertical line between the first position to the second position.

15. A lift wheelchair comprising:
a seat, a backrest, a footrest; and
a seat movement mechanism adapted to move the seat between a first position and a second position,
wherein the footrest is adapted to move horizontally as the seat movement mechanism moves the seat between the first position to the second position, a movement of the footrest is linked to the movement of the seat but is mechanically independent of the movement of the seat, a coordinated movement of the seat and the footrest is adapted to move a center of gravity of the user on a vertical line between the first position to the second position.

16. The lift chair of claim 15, wherein the seat movement mechanism is adapted to move the seat along a rectilinear travel line Co having a fixed non-zero angle α₁ relative to a vertical.

17. A lift wheelchair comprising:
a seat, a backrest, a footrest; and
a seat movement mechanism adapted to move the seat between a first position and a second position,
wherein the footrest is adapted to move horizontally as the seat movement mechanism moves the seat between the first position to the second position, a movement of the footrest is linked to the movement of the seat but is mechanically independent of the movement of the seat, the seat movement mechanism is adapted to move the seat along a rectilinear travel line Co having a fixed non-zero angle α₁ relative to a vertical.

18. The lift chair of claim 17, wherein a coordinated movement of the seat and the footrest is adapted to move a center of gravity of the user on a vertical line between the first position to the second position.

19. A lift wheelchair comprising:
a seat, a backrest, a footrest; and
a seat movement mechanism adapted to move the seat between a first position corresponding to a ‘sitting’ position and a second position corresponding to a ‘half-standing’ position,
wherein the footrest is adapted to move horizontally rearward as the seat movement mechanism moves the seat forward from the first position to the second position, a movement of the footrest is linked to the movement of the seat but is mechanically independent of the movement of the seat, the footrest and seat movements are such that ankles and knees of the user are moved horizontally with a lower leg of the user at a fixed angle αbdj with the horizontal.

20. The lift chair of claim 19, wherein a coordinated movement of the seat and the footrest is adapted to move a center of gravity of the user on a vertical line between the first position to the second position.
